(19) United States
(12) Patent Application Publication
(10) Pub. No.: US 2004/0018410 A1
(43) Pub. Date: Jan. 29, 2004

(54) Additive for direct methanol fuel cells

(76) Inventor: Hongli Dai, Wilmington, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/455,882

(22) Filed: Jun. 6, 2003

Related U.S. Application Data
(60) Provisional application No. 60/387,386, filed on Jun. 10, 2002.

(51) Int. Cl. H01M 8/10; C08J 5/22

(52) U.S. Cl. 429/33; 521/27

(57) ABSTRACT

Addition of Lewis bases to the fuel of direct methanol fuel cells reduces methanol and water transport through the fuel cell membrane. The Lewis bases employed have a pKa in their protonated form greater than the pKa of the acid groups of the fuel cell membrane.

### FIELD OF THE INVENTION

This invention relates to additives for direct methanol fuel cells.

### BACKGROUND OF THE INVENTION

Direct methanol fuel cells (DMFC) use methanol as fuel without first reforming the methanol to produce hydrogen. DMFC typically use about 1 to 6% by weight methanol in water as fuel. The fuel cell is made up of a cathode in its compartment and an anode in its compartment separated by a polymer membrane that has acid groups. A typical membrane is a fluoropolymer having sulfonic acid groups on the polymer chain. Such polymers are called ionomers, and membranes made from them, ionomer membranes. Perfluorinated ionomer and membranes are commercially available from E. I. du Pont de Nemours and Company under the trademark Nafion®.

Some of the methanol permeates through the membrane through diffusion and electro-osmotic drag. This is called methanol crossover. The rate of crossover of methanol through the membrane increases with the methanol concentration. Such crossover represents a loss of fuel cell efficiency because the crossover methanol is consumed without producing electric current. The membrane can be modified to reduce crossover, such as by increasing the equivalent weight, i.e. reducing the concentration of ion-exchange groups in the membrane. This reduces the conductivity of the membrane. Therefore the equivalent weight adjustment is a tradeoff of reduced conductivity to obtain reduced methanol crossover and optimize performance.

Addition of cesium ion have been disclosed (J. Electrochem. Soc. vol. 145, no. 11, p.3798-3801 [1998]) as a means of reducing methanol diffusion. Modification of the membrane by irradiation has also been proposed (J. Electrochem. Soc. vol. 148, no. 10, p. A1185-A1190, [2001]). These treatments add to the cost of the membrane.

Water transport from the anode to the cathode compartment is also excessively high in direct methanol fuel cells. This can cause flooding of the cathode and water accumulation in the cathode compartment.

Improved means of reducing methanol crossover and water transport through the membrane and of increasing fuel cell performance generally, are needed.

### SUMMARY OF THE INVENTION

This invention provides a direct methanol fuel cell comprising anode and cathode, a membrane comprising ionomer having ion-exchange groups separating the anode and cathode, and a fuel supply for supplying liquid methanol fuel to the anode, the membrane comprising at least one Lewis base, at least some of which is in its protonated form, the protonated form having a pKa greater than the pKa of at least some of the ion-exchange groups.

The invention also provides a direct methanol fuel cell comprising anode and cathode, a membrane comprising ionomer having ion-exchange groups separating the anode and cathode, and a fuel supply for supplying liquid methanol fuel to the anode, the fuel supply supplying methanol fuel comprising at least one Lewis base that in its protonated form has a pKa greater than the pKa of at least some of the ion-exchange groups.

In accordance with the invention, a process is provided for operating a direct methanol fuel cell comprising anode and cathode, a membrane comprising having ion-exchange groups separating the anode and cathode, and a fuel supply for supplying liquid methanol fuel to the anode, the process comprising contacting the membrane with at least one Lewis base that in its protonated form has a pKa greater than the pKa of at least some of the ion exchange groups.

In accordance with the invention, a fuel mixture is provided comprising methanol and at least one Lewis base.

### BRIEF DESCRIPTION OF THE DRAWING

FIG. 1 is a graphical representation of voltage and power as a function of current in a direct methanol fuel cell fueled with 20 wt % aqueous methanol fuel with and without additive according to this invention. FIGS. 2 and 3 show voltage as a function of current in the fuel cell fueled with 2 molar aqueous methanol fuel with and without additive.

### DETAILED DESCRIPTION

Ionomers for the membranes used in accordance with this invention may be any number of ion exchange polymers including polymers with cation exchange groups in the acid or proton form, hereinafter referred to as acid groups. Such acid groups include sulfonic acid groups, carboxylic acid groups, phosphonic acid groups, and boronic acid groups. Preferably, the ionomer has sulfonic acid and/or carboxylic acid groups.

Polymers for use in accordance with the present invention are preferably fluorinated, more preferably highly fluorinated ion-exchange polymers having sulfonic acid and/or carboxylic acid groups. “Fluorinated” means that at least 10% of the total number of univalent atoms in the polymer are fluorine atoms. “Highly fluorinated” means that at least 90% of the total number of univalent atoms in the polymer are fluorine atoms. Most preferably, the polymer is perfluorinated.

Preferably, the polymer comprises a polymer backbone with recurring side chains attached to the backbone with the side chains carrying the acid groups. Possible polymers include homopolymers or copolymers of two or more monomers. Copolymers are typically formed from at least one monomer which is a nonfunctional monomer and which provides carbon atoms for the polymer backbone. A second monomer provides both carbon atoms for the polymer backbone and also contributes the side chain carrying the acid group or its precursor, e.g., a sulfonyl halide group such as sulfonyl fluoride (—SO₂F), which can be subsequently hydrolyzed and converted to a sulfonic acid group; or a carbomethoxy group (—COOCH₃) which can be subsequently hydrolyzed to a carboxylic acid group. For example, copolymers of a first fluorinated vinyl monomer together with a second fluorinated vinyl monomer having a sulfonyl fluoride group (—SO₂F) can be used. Possible first monomers include tetrafluoroethylene (TFE), hexafluoropropylene, vinyl fluoride, vinylidine fluoride, trifluorethylene, chlorotrifluoroethylene, perfluoro(alkyl vinyl ether), hexafluoroisobutylene ((CH₂═C(CF₃)₂), ethylene, and mixtures thereof. Possible second monomers include a variety of fluorinated vinyl ethers with sulfonic acid groups or precursor groups which can provide the desired side chain in the polymer. Additional monomers can also be incorporated into these polymers if desired.

Other sulfonic acid ionomers are known and have been proposed for fuel cell applications. Polymers of trifluorostyrene bearing sulfonic acid groups on the aromatic rings are an example (U.S. Pat. No. 5,773,480). The trifluorostyrene monomer may be grafted to a base polymer to make the ion-exchange polymer (U.S. Pat. No. 6,359,019).

In addition to proton exchange membranes with fluorinated polymer backbones, other proton exchange membranes that are known to be useful in fuel cells are suitable in the practice of the present invention. For example, partially sulfonated poly(arylene)-etherketones membranes are known to the skilled in the art to be proton exchange membranes for fuel cells. Specific examples can be found in the literature (O. Savadogo, J. of New Materials for Electrochemical Systems, 1, 47-66, 1998).

A class of preferred polymers for use in the present invention includes a highly fluorinated, most preferably perfluorinated, carbon backbone and a side chain represented by the formula —(O—CF₂CFR_{f})ₐ—O—CF₂CFR′_{f}SO₃H, wherein R_{f} and R′_{f} are independently selected from F, Cl or a perfluorinated alkyl group having 1 to 10 carbon atoms, a=0, 1 or 2. The preferred polymers include, for example, polymers disclosed in U.S. Pat. No. 3,282,875 and in U.S. Pat. Nos. 4,358,545 and 4,940,525. One preferred polymer comprises a perfluorocarbon backbone and the side chain is represented by the formula —O—CF₂CF(CF₃)—O—CF₂CF₂SO₃H. Polymers of this type are disclosed in U.S. Pat. No. 3,282,875 and can be made by copolymerization of tetrafluoroethylene (TFE) and the perfluorinated vinyl ether CF₂═CF—O—CF₂CF(CF₃)—O—CF₂CF₂SO₂F, perfluoro(3,6-dioxa-4-methyl-7-octenesulfonyl fluoride) (PDMOF), followed by conversion to sulfonate groups by hydrolysis of the sulfonyl halide groups and ion exchanging if needed to convert to the desired form. One preferred polymer of the type disclosed in U.S. Pat. Nos. 4,358,545 and 4,940,525 has the side chain —O—CF₂CF₂SO₃H. This polymer can be made by copolymerization of tetrafluoroethylene (TFE) and the perfluorinated vinyl ether CF₂═CF—O—CF₂CF₂SO₂F, perfluoro(3-oxa-4-pentenesulfonyl fluoride) (POPF), followed by hydrolysis and ion exchange. Ion exchange is needed because sulfonyl fluoride is hydrolyzed in alkaline solution and a sulfonic acid salt results, such as potassium sulfonate. Because fuel cells use membranes with acid groups, the sulfonate is ion-exchanged with acid to convert it to the sulfonic acid.

In other preferred forms of the present invention, highly fluorinated carboxylic acid polymer, i.e., having carboxylic acid ion groups in the resulting composite membrane, is employed. The acid groups are represented by the formula —CO₂H. Preferably, the polymer comprises a polymer backbone with recurring side chains attached to the backbone with the side chains carrying the carboxylic acid groups, or more commonly, a precursor such as an alkyl ester of the carboxylic acid. Polymers of this type are disclosed in U.S. Pat. No. 4,552,631 and most preferably have the side chain —O—CF₂—CF(CF₃—O—CF₂CF₂CO₂H. This polymer can be made by copolymerization of tetrafluoroethylene (TFE) and the perfluorinated vinyl ether CF₂═CF—O—CF₂—CF(CF₃)—O—CF₂CF₂CO₂CH₃, methyl ester of perfluoro(4,7-dioxa-5-methyl-8-nonenecarboxylic acid) (PDMNM), followed by conversion to carboxylic acid by hydrolysis of the ester. The methyl ester is the preferred since it is sufficiently stable for melt fabrication, such as extrusion, and is easily hydrolyzed. In addition to or instead of the TFE comonomer mentioned above, other monomers can be used including hexafluoropropylene, vinyl fluoride, vinylidine fluoride, trifluorethylene, chlorotrifluoroethylene, perfluoro(alkyl vinyl ether), hexafluoroisobutylene ((CH₂═C(CF₃)₂), ethylene, and mixtures thereof.

In a preferred embodiment of the invention illustrated in the Examples which follow, the copolymers of tetrafluoroethylene (TFE) and perfluorovinyl ether (1) (PDMOF) provide ionomers with sulfonic acid groups. Also illustrated in the Examples are the copolymers of tetrafluoroethylene (TFE) and perfluorovinyl ether (2) (PDMNM) which provide ionomers with carboxylic acid groups.

CF₂═CF—O—CF₂CF(CF₃—O—CF₂CF₂SO₂F (1)

CF₂═CF—O—CF₂CF(CF₃—O—CF₂CF₂CO₂CH₃ (2)

Ionomer membranes employed in fuel cells in accordance with the invention preferably are about 5 μm to about 250 μm thick, more preferably about 10 to about 200 μm thick, most preferably about 20 to about 125 μm thick.

Ionomers may contain more than one type of acid group, for example by copolymerizing PDMOF and PDMNM and TFE. Membranes may be made up of more than one ionomer such as by blends of ionomers, or more usually multilayer constructions, such as by lamination or coextrusion of different ionomers. Multilayer membranes comprised of layers of carboxylic acid and sulfonic acid ionomers are commercially available from E. I. du Pont de Nemours and Company under the trademark Nafion®. In bilayer membranes useful for the practice of the present invention, the carboxylic acid ionomer layer is preferably about 1 to 125 μm thick, more preferably about 1 to 50 μm thick, most preferably about 2 to 25 μm thick; the sulfonic acid ionomer layer is preferably about 5 to 125 μm thick, more preferably about 10 to 50 μm thick. The preferred orientation of the bilayer membrane in the fuel cell is with the carboxylic acid ionomer layer toward the anode.

Ionomers used in membranes are ordinarily characterized by their equivalent weight (EW), which is the weight of polymer in the hydrogen-ion or acid form in grams that will neutralize one equivalent of base. For the TFE/PDMOF and TFE/PDMNM polymers described above, equivalent weights are in the range of 700 to 1500, preferably about 800-1350, more preferably about 850 to 1200, most preferably about 900 to 1100. Because equivalent weight is influenced by the molecular weight of the vinyl ether, an alternative way has been developed for characterizing ionomer ion exchange capacity independently of the molecular weight. This is the ion-exchange ratio (IXR). IXR is the number of carbon atoms in the polymer backbone divided by the number of ion-exchange groups. For the copolymers of TFE and vinyl ether (1), described above, IXR is related to equivalent weight (EW) by the equation: (EW=50×IXR+344). The IXRs corresponding to the EW ranges given above are about 8 to 24, preferably about 10 to 21, more preferably about 12 to 18. The IXR applies regardless of how the ion-exchange group is attached to the polymer backbone. For the copolymers of TFE and vinyl ether (2), described above, IXR is related to equivalent weight (EW) by the equation: (EW=50×IXR+308).

Sulfonic acid ionomer membranes have been membranes of choice in fuel cells because of the facility with which these membranes transport protons, i.e. sulfonic acid ionomer membranes have high proton conductivity.

Reinforced ion exchange polymer membranes can also be used in the practice of the present invention. Reinforced membranes can be made by impregnating porous, expanded PTFE (ePTFE) with ion exchange polymer. ePTFE is available under the tradename Tetratex® from Tetratec, Feasterville Pa., and under the tradename Goretex® from W. L. Gore and Associates, Inc., Elkton Md. Impregnation of ePTFE with perfluorinated sulfonic acid ionomer is disclosed in U.S. Pat. Nos. 5,547,551 and 6,110,333 (also discloses reinforced bilayer membrane manufacture). Similar impregnation can be done using solutions of esters of carboxylic acid ionomers (U.S. Pat. No. 5,273,694) followed by hydrolysis and acid exchange as is known in the art. The reinforcement provides increased strength and permits use of thinner membranes, and also contributes to greater dimensional stability of the membrane.

Surprisingly, it has been found that if the membrane of a direct methanol fuel cell includes a certain additive, such as by being in contact with a methanol fuel including the additive, direct methanol fuel cells using acid membranes show lower methanol crossover and lower water transport.

In the present application, “methanol fuel” refers to the fuel in contact with the anode and the membrane. “Fuel mixture” is methanol and Lewis base, with or without water. “Fuel supply” is the apparatus for supplying methanol fuel to the anode.

The additive is at least one Lewis base, specifically a Lewis base that is more basic than the conjugate base of the acid group of the ionomer, i.e. the sulfonate if the acid group is sulfonic acid, the carboxylate if the acid group is carboxylic acid. Another way of stating this is: the pKa of the protonated Lewis base should be greater than the pKa of at least some of the acid groups of the membranes, e.g., for the preferred ionomers the sulfonic acid of the ionomer of the sulfonic acid membrane, or of the carboxylic acid of the ionomer of the carboxylic acid membrane. Preferably, the pKa of the protonated Lewis base should be at least about 0.1 pKa unit greater, more preferably at least about 1 pKa units greater, most more preferably at least about 2 pKa units greater. The pKa of the protonated Lewis base preferably is less than about 14, more preferably less than about 12, most preferably less than about 8.

This invention uses the standard definition of pKa, which can be found in “The Determination of Ionization Constants” by Adrien Albert and E. P. Serjeant (page 4, Chapman and Hall, 1984). Therefore, the pKa is defined as the negative logarithm of the ionization constant, in this case, of the protonated base.

By Lewis base is meant an electron pair donor that is not the conjugate base of a Bronsted acid, that is, it is not a base formed when a Bronsted acid donates a proton. For example, hydroxide ion, the conjugate base of the Bronsted acid water, is not a Lewis base according to this invention. Similarly, acetate, the conjugate base of the Bronsted acid acetic acid, is not a Lewis base according to this invention.

The Lewis base of this invention is preferably an organic Lewis base. By organic is meant that the Lewis base contains at least one carbon atom that is covalently bonded to at least one atom of hydrogen, carbon, or nitrogen.

Lewis bases that are effective according to this invention include but are not limited to imidazoline (C₃H₆N₂), piperidine (C₅H₁₁N), piperazine (C₄H₁₀N₂), pyrrolidine (C₄H₉N), aziridine (C₂H₅N), azetidine (C₃H₇N), imidazole (C₃H₄N₂), pyrazole(C₃H₄N₂), and pyridine (C₅H₅N). Imidazoline and piperidine are preferred. The protonated form of these Lewis bases all have pKas higher than that of the sulfonic acid derived from (1) or the carboxylic acid groups derived from (2), above. These Lewis bases may be substituted, for example by alkyl or aryl groups, so long as such substitution does not alter their Lewis base character or change the pKas of the protonated forms of the Lewis bases so that the pKas do not exceed those of the acid groups in the ionomer membrane. Examples of such substituted forms of these Lewis bases are 2-methyl-2-imidazoline (C₄H₈N₂), 4,4-dimethyl-2-imidazoline (C₅H₁₀N₂), 2-ethyl-4-methylimidazole (C₆H₁₀N₂), 2,6-dimethylpyridine (C₇H₉N), 2,6-dimethylpiperidine (C₇H₁₅N), and 4,4′-trimethylenedipiperidine (C₁₃H₂₆N₂). Other substituted forms are known to those skilled in the art. Preferred are water soluble macromolecules including oligomers and polymers with the aforementioned Lewis bases as part of the polymer chain, or as the terminating groups of the main chain or as pendant groups distributed along the polymer chain.

When a Lewis base according to this invention is present in the acid membrane, at least some fraction of the Lewis base is protonated by the acid groups, and therefore the Lewis base is in its protonated form. For example, if imidazole is used as the Lewis base, at least some of it is converted to the imidazolium ion.

It will be recognized that because of variations in copolymerization such as occur due to accidental or intentional changes in monomer feed rates, temperatures, and initiator feed rates, and in variations in polymer morphology due to thermal history, not all acid groups will be in the same environment and therefore may have somewhat different pKas. Also, polymers may be made using two or more comonomers having acid functionality or the precursor thereto. In this case too, the acid groups will not have identical pKas. For polymers like these, the pKa or the protonated form of the Lewis base need only be greater than the pKa of some of the acid groups, preferably greater than 25 mol % of such groups, more preferably greater than 50 mol %, still more preferably greater than 75 mol %, and most preferably greater than 90 mol % of such acid groups.

Except for the use of the use of the Lewis base additive and any additional components or modifications to accommodate the additive, conventional direct methanol fuel cell materials and designs can be employed in the practice of the present invention.

In a preferred form of the invention in which the methanol fuel for the fuel cell includes the additive and the membrane is contacted with the Lewis base of this invention by the Lewis base being present in the methanol fuel, it is desirable that the Lewis base selected be soluble in the methanol fuel under the conditions of temperature and concentration at which the methanol fuel is used in the fuel cell. Similarly, for any fuel mixtures to be supplied to the fuel cell which incorporate the Lewis base, the Lewis base should be soluble in the fuel mixture at the desired concentration.

The concentration of the Lewis base in the methanol fuel is at least about 0.001, preferably at least about 0.005, and more preferably at least about 0.01; no more than about 1.0 molar, more to preferably no more than about 0.5 molar, and more preferably no more than about 0.3 molar. The Lewis base may advantageously be premixed with the fuel mixture supplied to the fuel cell, in which case concentrations can be in the same preferred ranges as the methanol fuel, or may be added to the fuel mixture during operation of the fuel cell.

In another embodiment of the invention, the membrane is pretreated with Lewis base and incorporation of Lewis base in the methanol fuel is unnecessary, at least at the startup of the fuel cell. The Lewis base may be added to the membrane by dipping or soaking in, coating, or spraying with a solution of Lewis base. Another way of introducing Lewis base into the membrane is by vapor deposition. The Lewis base is carried to the membrane in a gas stream. An inert carrier gas such as nitrogen can be used and heat advantageously applied as needed to ensure that the Lewis base has adequate vapor pressure so that the desired amount of Lewis base is carried to the membrane in a reasonable time. Alternatively, if the membrane is cast from solution, the Lewis base may be added to the solution before casting.

To practice this invention using sulfonic acid proton exchange membranes, the amount of Lewis base in the methanol fuel should be enough to maintain Lewis base in the membrane sufficient to react with about 0.1 to 100% of the acid groups in the membrane, forming protonated Lewis base, assuming that the Lewis base reacts quantitatively with the sulfonic acid group. Note that the assumption of quantitative reaction is made for the purpose of defining the amount of Lewis base and not to specify or limit to what extent if any, reaction occurs. Preferably enough Lewis base is present to react with about 2 to 50% of the acid groups in the membrane, more preferably enough to react with about 2 to 10% of the acid groups in the membrane.

Because optimum fuel cell performance, including as it does the acceptable level of methanol and water crossover as well as acceptable power output, depends upon the application, the optimum amount of additive will also vary with application. Fuel cells in which limited crossover is the most desirable attribute, will perform best with more additive. Fuel cells that are subject to high power demand, will perform best with lesser amounts of additive.

To practice this invention using carboxylic acid proton exchange membranes, the Lewis base in the methanol fuel should be enough to maintain Lewis base in the membrane sufficient to react with about 1 to 100% of the carboxylic acid groups in the membrane, forming protonated Lewis base, assuming that the Lewis base reacts quantitatively with the acid group. Preferably at least enough Lewis base is present to react with about 10 to 100% of the acid groups in the membrane, more preferably at least enough to react with about 25 to 100% of the acid groups in the membrane, still more preferably at least enough to react with about 50 to 100% of the acid groups in the membrane and most preferably at least enough to react about 80 to 100% of the acid groups in the membrane. If there is an excess of Lewis base, it should preferably amount to no more than about twice the number of equivalents of acid groups in the membrane, preferably no more than about 1.5 times the number of equivalents of acid groups in the membrane, and more preferably no more than about 1.1 times the number of equivalents of acid groups in the membrane.

Because of the low methanol crossover in fuel cells according to this invention, it is possible to use more concentrated methanol fuels. Conventional direct methanol fuel cells typically use methanol fuels containing about 1 to 6 weight percent (wt %) methanol in water. Depending upon the type of membrane and other factors, fuel cells according to this invention can operate on methanol fuels having a wide range of concentrations from about 0.1 wt % methanol in water to 99 wt % methanol. Preferably, the concentration range is about 1 to about 80 wt % methanol. More preferably, a methanol fuel of methanol in water having about 1 to about 50 wt % methanol is used. Fuel cells according to this invention employing sulfonic acid membranes can operate with about 0.1 to 99 wt % methanol in water, preferably about 1.5 to 80 wt %, more preferably about 0.1 to 30 wt % methanol in water, preferably about 1.5 to 20 wt %, most preferably about 3 to 20 wt %. Fuel cells according to this invention employing carboxylic acid membranes can operate with about 0.1 to 99 wt % methanol in water, preferably about 1 to 80 wt %, more preferably about 0.1 to 64 wt % methanol in water, still more preferably about 1 to 50 wt %, still more preferably about 5 to 40 wt %, and most preferably, about 15 to 30%.

The methanol fuel for the fuel cell can be supplied by a fuel supply which can be a single container, or it may made a plurality of containers from which feeds are mixed. For example, a three-container system could have separate containers of methanol, water, and Lewis base. A two-container system could have separate containers, one of methanol plus water, the other of Lewis base, or preferably a fuel mixture including Lewis base in methanol which may contain water. If water is present, the fuel mixture advantageously has the same percentages of methanol and water discussed above for the methanol fuel. Water generated by the fuel cell can be a source of water for the fuel supply. Therefore, the fuel supply can be fed from a fuel concentrate which may contain up to 100% methanol or only methanol and the Lewis base additive. The concentrate is added to the operating fuel cell to keep the methanol fuel in desired concentration range.

The Lewis base is not consumed at the rate at which methanol is consumed in the fuel cells of this invention and therefore, depending upon operating conditions such as temperature and current density, the concentration of the Lewis base in the methanol fuel mixture during operation may increase in the membrane and/or the fuel reservoir. In this event, the Lewis base concentration can be maintained by reducing the amount of Lewis base being added to the methanol fuel. The Lewis base may be added to the methanol fuel intermittently when operating conditions indicate a drop in performance. This process can be automated, for example, by monitoring the amount of methanol and water being consumed and using the monitor signal to control a metering system to add Lewis base to the methanol fuel as necessary to maintain performance. Alternatively, the Lewis base concentration may be reduced to the level necessary to maintain low water transport and methanol crossover or fuel cell performance. It will be recognized that “performance” is not a monolithic concept. In the case of fuel cells, according to circumstances, it may refer to cross-over of methanol or water transport, to voltage or to power output.

Because the amount of Lewis base in the fuel needed for “make up” or to maintain the desired steady-state concentration of Lewis base in the membrane may be less than needed at the start of operation, the concentration of Lewis base in fuel of a cell that is in operation may be lower.

The choice of IXR of the membrane according to this invention depends upon the balance between conductivity and water transport and methanol crossover desired by the user. At lower IXR, membrane conductivity increases, as is expected from greater ion-exchange capacity of the membrane. However, with increasing conductivity, increasing water transport and methanol crossover is also seen. Therefore, with membranes now used in fuel cells, practice according to this invention will give reduced water transport and methanol crossover. Alternatively, in a fuel cell according to this invention, a lower IXR membrane can be used to increase membrane conductivity without increasing water transport and methanol crossover. Fuel cells with more conductive membranes show higher performance.

For portable devices powered by fuel cells designed according to this invention, containers of fuel will be convenient for refueling the cell. The containers can be made from polymer or metal materials suitable for the fuel, i.e. having low permeability to the fuel components and being resistant to interaction with the fuel components. It is preferred that the container be substantially nonvitreous, that is, not be made of glass or other vitreous material, though such material may comprise no more than about 10% of the total mass of the container, preferably no more than about 5%. Such containers will have at least one dispensing port, sealed by a cap or plug, or other sealing means, such as by a foil membrane, or preferably a septum of elastomeric material. The contents of the container may be used to fill the anode compartment of the fuel cell when fuel replenishment is necessary. Alternatively, the fuel cell can be designed to accept such containers, so they may be joined to the cell, replacing empty containers that have been removed. In either case, the container may hold a concentrated fuel mixture to which water is added to achieve the desired methanol fuel composition. The water may be in a separate compartment and may be water that is generated during operation of the fuel cell. In this respect, the containers may be used as disposable batteries are now used in devices such as flash lights and portable radios and may be used to provide an instant “recharge” for devices such as cell phones, portable computers, and portable digital assistants which currently employ rechargeable batteries.

### EXAMPLES

Method of Measuring Membrane Conductivity

The membrane sample is loaded on a four point conductivity probe. The probe has a base plate that measures 1.9″×1.5″×0.385″ (4.8 cm×3.8 cm×0.978 cm) and a cover plate 1.9″×1.23″×0.25″ (4.8 cm×3.1 cm×0.64 cm). Four 0.5″ (1.3 cm) long platinum wires (30 GA, Hauser and Miller Precious Metals) are fixed on top of four 0.05″ (0.13 cm) wide ridges along the width direction of the base plate. The outer two probes has a spacing of 1″ and the inner two probes has a spacing of 0.4″ (1 cm). In between the ridges, the space is open so that membrane is exposed to the environment. The membrane sample, typically 1 cm wide and 3.25 cm long is pressed against the four platinum probes with the cover plate by a clamp. The membrane is also exposed to the environment on the cover plate side, which also has the openings. The four platinum wires are connected electrically to a Solatron impedance measurement system consisting of a SI1287 electrochemical interface and a 1255B frequency response analyzer. To measure the membrane conductivity, the probe is dipped into a 500 ml glass beaker filled with the desired solution so that the membrane is fully exposed to the solution. The glass beaker is wrapped with heating tape, which is connected to a digital thermal controller. The thermocouple of the controller is immersed in the solution so that the solution temperature is precisely controlled to within ±0.5° C.

Since the solution itself may have finite conductivity, it is important to correct for that in the measurement. This can be accomplished by measuring separately the resistances of the cell when the membrane sample is loaded (R) and when a thin Teflon® film is loaded (R₀). The resistance (Rs) due to the sample is then calculated by the formula: Rs=R×R₀/(R₀−R). The sample membrane conductivity is calculated by the formula: σ=L/(Rs×A) where σ is conductivity (S/cm), L (cm) is the spacing between the inner two wires and A (cm²) is the cross sectional area of the membrane.

Methanol and Water Crossover (Permeation Rate Through the Membrane)

The membrane samples are loaded in permeation cells (316 stainless steel, Millipore® high-pressure, 47 mm filters modified by the addition of liquid distribution plates). Each cell has a permeation area of 9.6 cm². The cells (up to 4 per run) are located inside an insulated box kept at constant temperature. The insulated box is heated by two Chromalox, 1100 watt, finstrips heaters. The air within the box is mixed by a 7″ (18 cm) diameter, 5-blade propeller connected to a Dayton Model 4Z140 variable speed DC motor. The insulated box temperature is controlled by a Yokogawa UT320 Digital indicating temperature controller.

Methanol solution is circulated on the top side of the membrane at a flow rate of 5.7-9.6 cc/min (measured with Brook Instruments, Model 1355EYZQFA1G rotameters). The bottom of the membrane is swept with nitrogen at 1,000-5,000 standard cubic centimeters (sccm) (measured with 2 MKS type 1179 and 2 Tylan 2900 series mass flow meters connected by a Tylan RO-28 controller box). Both the methanol solution and the nitrogen are heated to the cell temperature by circulating through stainless steel coils before entering the permeation cells. Samples of the nitrogen sweeping the permeation cells are sent to a set of heated Valco valves and then a 2 cc gas sample is injected into a HP 6890 Gas Chromatograph with a Thermal Conductivity Detector (TCD) and HP-PLOT Q GC Column to analyze for methanol and water content. The GC is controlled by HP Chem Station software Revision A.06.03.

The permeation rates (molar fluxes) of methanol and water through the membrane are calculated as:

Methanol Molar flux (mol/cm² min) = grams MeOH × F/
(Vnitrogen × Ap × MWMeOH)
Water Molar flux (mol/cm² min) = grams Water × F/
(Vnitrogen × Ap × MWWater)
Where:
grams MeOH = MeOH Peak Area × MeOH Response Factor = Grams
methanol Injected in GC.
grams Water = Water Peak Area × Water Response Factor = Grams
water Injected in GC.
Vnitrogen = Vs − grams MeOH /ρ MeOH − grams Water/ρ
Water = Volume of nitrogen injected in GC (cm³)
Vs = Volume Gas Sample injected into GC (cm³)
Ts = Temperature of Gas sample = Temperature of sampling valve
(° K.)
Ps = Pressure of gas sample (psia)
ρ Nitrogen = Density of nitrogen at Ts and Ps (g/cm³)
ρ MeOH = Density of Methanol at Ts and Ps (g/cm³)
ρ Water = Density of Water at Ts and Ps (g/cm)
Ap = Permeation Area of cells (cm²)
F = Flow of nitrogen sweeping membrane at Ts, Ps (cm³/min)

The methanol and water response factors are calculated by injecting known amounts of methanol and water into the GC. It is the ratio: grams of component injected/peak area.

### Example 1

Nafion® 117 (available from the DuPont Company, Wilmington Del. USA) a sulfonic acid membrane made of a copolymer of TFE and PDMOF, having an equivalent weight of about 1050, and a thickness of about 7 mils (180 μm) is tested at about 30° C. with methanol fuel for methanol and water permeation rate as a function of imidazole content of the aqueous methanol. pKa(sulfonic acid ionomer)≅0, pKa(imidazolium)=7, thus pKa(protonated additive)>pKa(ionomer). Nitrogen flow is 3012 standard cc/min. It is found that permeation rate is significantly lower with just 0.05 M imidazole. Table 1 summarizes the results.

TABLE 1
Nafion ® 117 Permeation rate at 32-33° C.,
20% Methanol:80% Water (wt/wt)

| Methanol Permeation rate | Water Permeation rate | Imidazole molar |
|---|---|---|
| (10⁻⁶ gmol/cm² min) | (10⁻⁵ gmol/cm² min) | concentration |
| 32 | 28 | 0 |
| 6.9 | 9.4 | 0.05 |
| 5.6 | 6.6 | 0.1 |
| 4.7 | 5.4 | 0.2 |

### Example 2

Example 1 is repeated but at 60° C. Again it is found that permeation rate is significantly lower with just 0.05 M imidazole. Table 2 summarizes the results.

TABLE 2
Nafion ® 117 Permeation rate at 62-63° C.,
20% Methanol:80% Water (wt/wt)

| Methanol Permeation rate | Water Permeation rate | Imidazole molar |
|---|---|---|
| (10⁻⁶ gmol/cm² min) | (10⁻⁵ gmol/cm² min) | concentration |
| 60 | 57 | 0 |
| 11 | 14 | 0.05 |
| 9.4 | 9.3 | 0.1 |
| 10 | 8.3 | 0.2 |

### Example 3

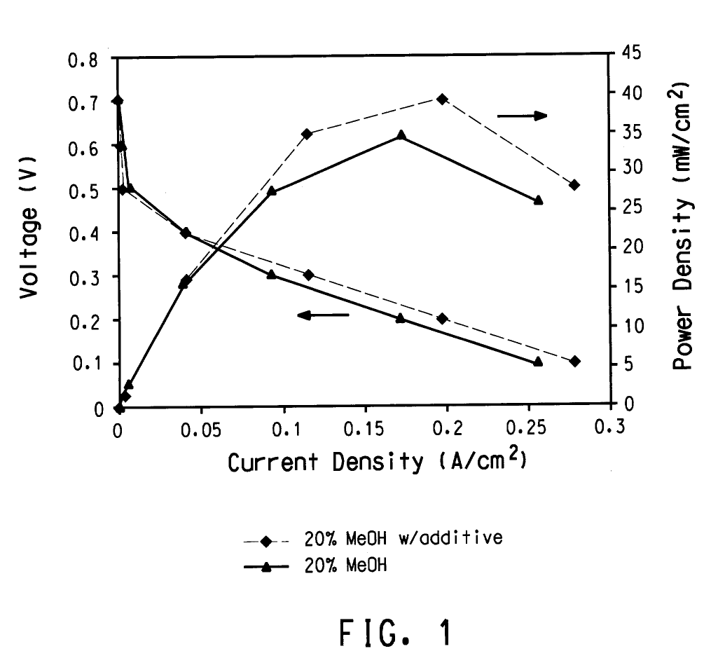

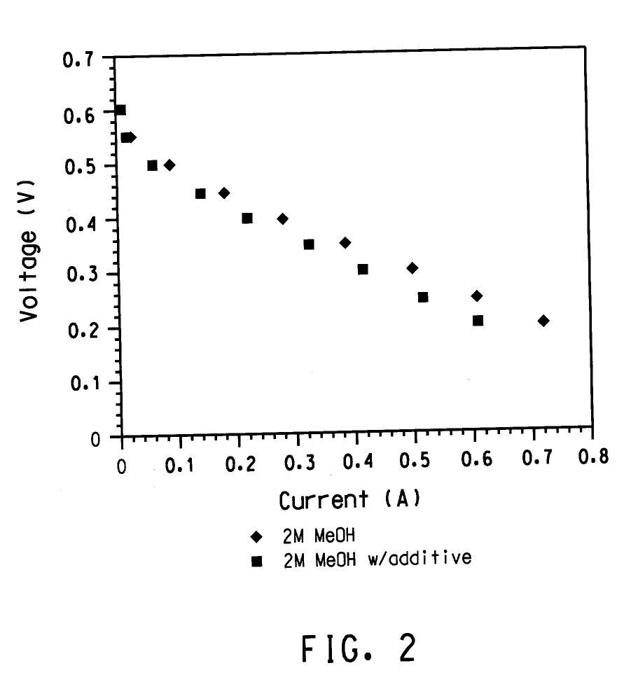

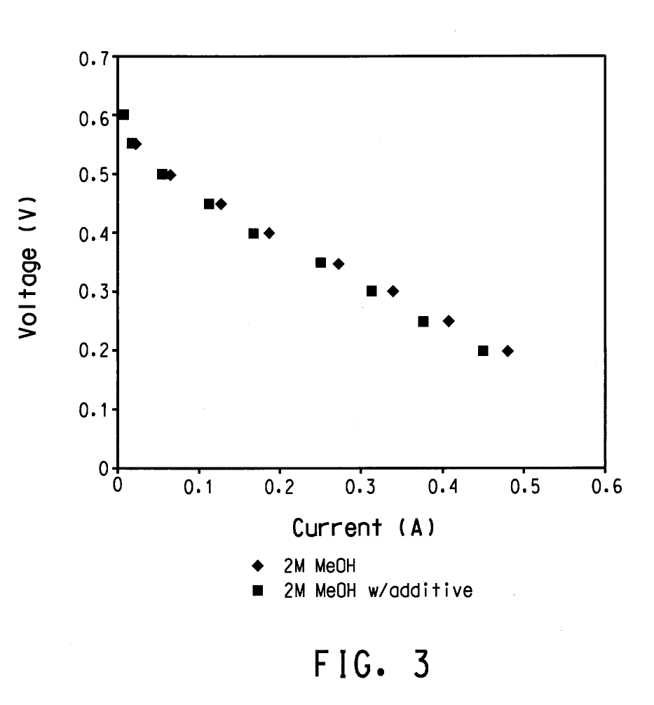

A direct methanol fuel cell is operated with a Nafion® 117 membrane, 1050 EW, 7 mils (178 μm) thick. The cell active area is 5 cm². The anode catalyst layer is comprised of 4 mg/cm² Pt/Ru (1:1 atom ratio) black and 0.5 mg/cm² of a copolymer of TFE and PDMOF of EW 1050 hydrolyzed and in solution, about 5 wt % polymer, available from Aldrich Chemical Company, Milwaukee Wis. USA. The cathode catalyst is comprised of 4 mg/cm² platinum black and 0.5 mg/cm² the above-described TFE/PDMOF hydrolyzed polymer in solution. The cell body is made of polytetrafluoroethylene and is comprised of an anode compartment that measures 4 cm×3 cm×2.5 cm. The cathode compartment is open to the environment to allow access to air. There is no forced methanol fuel or air flow. Operating temperature is 25° C. The methanol fuel is 20 wt % methanol in water. The cell is operated with the methanol fuel alone and with methanol fuel to which 0.05 molar imidazole has been added. Performance is significantly improved when methanol fuel with additive is used. FIG. 1 summarizes the results. The cell operated for about 5 minutes at each stage, with measurements being made about every 10 seconds. Averaged results are presented in the figure.

### Example 4

This Example uses the fuel cell described in Example 3. Methanol fuel is put into this compartment and there is no circulation during fuel cell operation. The cathode compartment is tightly covered with a plate made of titanium and through this plate, constant flow of 200 sccm of dry air is supplied to the surface of the cathode. Operating temperature is 30° C. The same cell is operated first with 2 molar methanol fuel with no additive, then with 2 molar methanol fuel to which 0.025 molar 2-methyl-2-imidazoline (C₄H₈N₂, Aldrich Chemical Company, 95%) has been added. The fuel cell voltage-current relationship is shown in FIG. 2. With additive, the fuel cell output current is lower than without additive at the same voltage. However, methanol crossover is reduced with additive. Methanol crossover in the cell with and without additive were measured voltammetrically according to the method of X. Ren et al. (J. Electrochemical Society, 147 (1), 92-98 (2000)). When measuring the crossover current, 200 sccm dry N₂ is supplied to the cathode side of the fuel cell and a voltage of 0.8V is applied to the cell (cathode side positive). The steady state current is taken as the methanol crossover current. When the fuel is 2 molar MeOH without any additive, the crossover current density is 120 mA/cm²; when the fuel is 2 molar MEOH with 0.025 molar 2-methyl-2-imidazoline, the crossover current density is reduced to 105 mA/cm².

### Example 5

The same cell and operating conditions are used as in Example 4. The cell is operated first with 2 molar methanol fuel with no additive, then with 2 molar methanol fuel to which 0.025 molar 2,6-dimethylpiperidine (C₇H₁₅N, Aldrich, 98%) has been added. The fuel cell voltage-current relationship is shown in FIG. 3. At cell voltages above 0.4V, the fuel cell output current with or without additive is the same within our measurement error. At cell voltages below 0.4 V, the fuel cell output current is slightly lower than without additive at the same voltage. However, methanol crossover is reduced with additive. Methanol crossover is measured according to the method described in Example 4. When the fuel is 2 molar MeOH without any additive, the crossover current density is 112 mA/cm²; when the fuel is 2 molar MeOH with 0.025 molar 2,6-dimethylpiperidine, the crossover current density is reduced to 98 mA/cm².

In comparison to the Lewis base of Example 4, the larger 2,6-dimethylpiperidine shows improved power output.

Carboxylic Acid Ionomer Membrane Preparation Method

Carboxylic acid perfluoroionomer, a copolymer of TFE and PDMNM, in the form of pellets of equivalent weight 1054 is spread in a 2-mil thick chase and sandwiched between two sheets of Teflon® PFA film. This combination is inserted between two flat stainless steel plates and put in a Carver hotpress at 225° C. After heating for 3 minutes, 20,000 lbs force is applied for 1 minute. After removal from the hotpress, the combination is cooled and opened and the resulting film is cut out of the chase. The following procedure is used to convert the film from methyl ester form to the acid form:

1. Treat the film in 10% KOH at 90° C. for 2 hours.

2. Replace the KOH solution with fresh one, and treat the membrane again at 90° C. in 10% KOH for 1 hour.

3. Rinse the membrane in nanopure water several times

4. Treat the sample at 80° C. in 15% by volume aqueous HNO₃ solution for 2 hours and then repeat this process with fresh solution.

6. The film is then rinsed with nanopure water several times.

7. The film is then boiled in nanopure water for 1 hr.

8. Step 7 is repeated.

### Example 6

A methanol fuel is made consisting of 0.2 molar imidazole in MeOH/H₂O (1:4 by wt.). pKa(imidazolium)=7. A TFE/PDMNM carboxylic acid (eq. wt. 1054) membrane is prepared as described above. A sample is mounted on the conductivity probe. pKa(carboxylic acid resin)=2, thus pKa(protonated additive)>pKa(ionomer). The sample probe is placed in the beaker filled with solution at 60° C.

AC impedance is used to measure the conductivity. Correction is made to eliminate the background conductivity due to the solution itself. The conductivity of the membrane is 13.3 mS/cm.

MeOH and H₂O permeation rate of carboxylic acid membrane is measured at 60° C., in the above solution. MeOH permeation rate is 2.37·10⁻⁷ mol/(cm² min). Water permeation rate is 1.38·10⁻⁶ mol/(cm² min). This Example shows that the conductivity of this carboxylic acid membrane is improved about 25 times compared to the same membrane without Lewis base additive: see Comparative Example A, which follows.

### Comparative Example A

Conditions are the same as Example 4 except that no imidazole is added to the methanol fuel solution. The conductivity of the membrane is 0.5 mS/cm. MeOH permeation rate at 60° C. is 3.34·10⁻⁷ mol/(cm² min) and water permeation rate is 1.73·10⁻⁶ mol/(cm² min). In the absence of fuel additive, the membrane is about 25 times less conductive.

### Comparative Example B

Nafion® 117 membrane crossover properties are measured in MeOH/H₂O (1:4) solution. MeOH permeation rate at 60° C. is 6·10⁻⁵ mol/(cm² min) and that of water is 5.7·10⁻⁴ mol/(cm² min). By comparison with Example 6, it can be seen that permeation rate to methanol is lower for the carboxylic acid membrane by about 200 times, and permeation rate to water by about 300 times.

### Example 7

A direct methanol fuel cell is operated with a bilayer membrane made by coextrusion of a TFE/PDMOF copolymer and a TFE/PDMNM copolymer, followed by conversion to acid form by the hydrolysis and acid exchange steps described in membrane preparation methods. The carboxylic acid ionomer layer is 0.1 mil thick with EW in the range of 940 to 1055. The sulfonic acid ionomer layer is 3.5 mil thick with EW in the range of 1000 to 1100. The bilayer membrane is. The cell active area is 5 cm². The anode catalyst layer is comprised of 4 mg/cm² Pt/Ru (1:1 atom ratio) black and 0.5 mg/cm² perfluorosulfonic acid. The cathode catalyst is comprised of 4 mg/cm² Pt black and 0.5 mg/cm² perfluorosulfonic acid. The anode catalyst is applied on the carboxylic acid ionomer side and the cathode catalyst on the sulfonic acid ionomer side of the membrane. The cell body is made of polytetrafluoroethylene and is comprised of an anode compartment that measures 4 cm×3 cm×2.5 cm. The cathode compartment is open to the environment to allow access to air. Operating temperature is 30° C. The fuel is a fuel mixture containing methanol (20 wt %) and 0.05M imidazole in water. The cell with this fuel achieved open circuit voltage of 0.78±0.02 V and current of 0.12±0.02 mA at cell voltage of 0.3V.

What is claimed is:

1. A direct methanol fuel cell comprising anode and cathode, a membrane comprising ionomer having acid groups separating said anode and cathode, and a fuel supply for supplying liquid methanol fuel to said anode, said membrane comprising at least one Lewis base, at least some of which is in its protonated form, said protonated form having a pKa greater than the pKa of at least some of said acid groups.

2. The fuel cell of claim 1 wherein said acid groups comprise at least one of sulfonic acid groups and carboxylic acid groups.

3. The fuel cell of claim 1 wherein said membrane comprises fluorinated ionomer.

4. The fuel cell of claim 1 wherein said at least one Lewis base is an organic compound.

5. The fuel cell of claim 1 wherein said at least one Lewis base is selected from the group consisting of imidazoline, piperidine, piperazine, pyrrolidine, aziridine, azetidine, imidazole, pyrazol, pyridine, and their substituted forms.

6. The fuel cell of claim 1 wherein said at least one Lewis base is selected from the group consisting of imidazoline and piperidine.

7. The fuel cell of claim 1 wherein said fuel supply supplies a methanol fuel comprised of methanol and water.

8. The fuel cell of claim 7 wherein the amount of methanol in the methanol fuel is about 0.1 to about 99 wt %.

9. The fuel cell of claim 1 wherein said membrane is a multilayer membrane.

10. The fuel cell of claim 1 wherein said membrane comprises a layer of ionomer having sulfonic acid groups and a layer of ionomer having carboxylic acid groups.

11. The fuel cell of claim 10 wherein said membrane is oriented in said cell with said layer of ionomer having carboxylic acid groups toward said anode.

12. A direct methanol fuel cell comprising anode and cathode, a membrane comprising ionomer having acid groups separating said anode and cathode, and a fuel supply for supplying liquid methanol fuel to said anode, said fuel supply supplying methanol fuel comprising at least one Lewis base that in its protonated form has a pKa greater than the pKa of at least some of said acid groups.

13. The fuel cell of claim 12 wherein said acid groups comprise at least one of sulfonic acid groups and carboxylic acid groups.

14. The fuel cell of claim 12 wherein said membrane comprises a fluorinated ionomer.

15. The fuel cell of claim 12 wherein said at least one Lewis base is selected from the group consisting of imidazoline, piperidine, piperazine, pyrrolidine, aziridine, azetidine, imidazole, pyrazole, pyridine, and their substituted forms.

16. The fuel cell of claim 12 wherein said at least one Lewis base is selected from the group consisting of imidazoline and piperidine.

17. The fuel cell of claim 12 wherein said at least one Lewis base in said methanol fuel has a concentration of at least about 0.001 M.

18. The fuel cell of claim 12 wherein said methanol fuel is comprised of methanol and water.

19. The fuel cell of claim 18 wherein the amount of methanol in the methanol fuel is about 0.1 to about 99 wt %.

20. The fuel cell of claim 12 wherein said membrane is a multilayer membrane.

21. The fuel cell of claim 12 wherein said membrane comprises a layer of ionomer having sulfonic acid groups and a layer of ionomer having carboxylic acid groups.

22. The fuel cell of claim 21 wherein said membrane is oriented in said cell with said layer of ionomer having carboxylic acid groups toward said anode.

23. A process for operating a direct methanol fuel cell comprising anode and cathode, a membrane comprising ionomer having acid groups separating said anode and cathode, and a fuel supply for supplying liquid methanol fuel to said anode, said process comprising contacting said membrane with at least one Lewis base that in its protonated form has a pKa greater than the pKa of at least some of said acid groups.

24. The process of claim 23 wherein said acid groups comprise at least one of sulfonic acid groups and carboxylic acid groups.

25. The process of claim 23 wherein said membrane comprises a fluorinated ionomer.

26. The process of claim 23 wherein said contacting of said membrane with Lewis base is carried out by incorporating said at least one Lewis base as an additive to said methanol fuel.

27. The process of claim 26 wherein said at least one Lewis base in said methanol fuel has a concentration of at least about 0.001 M.

28. The process of claim 26 wherein said at least one Lewis base is present as an additive in the methanol fuel at the startup of the fuel cell.

29. The process of claim 26 wherein said at least one Lewis base is present as an additive in the methanol fuel during operation of the fuel cell.

30. The process of claim 23 wherein said contacting of said membrane with at least one Lewis base is adjusted to control fuel cell performance.

31. The process of claim 30 wherein said contacting is adjusted to control a performance characteristic selected from the group consisting of voltage, amperage, power output, methanol crossover, and water crossover.

32. The process of claim 23 wherein said contacting is performed before fuel cell is put into operation.

33. The process of claim 32 wherein said contacting of membrane with Lewis base is done by a method selected from the group consisting of soaking, dipping, spraying, and coating said membrane with said Lewis base, by vapor deposition, and by casting said membrane from a solution containing Lewis base.

34. A fuel mixture comprising methanol and at least one Lewis base.

35. The fuel mixture of claim 34 further comprising water.

36. The fuel mixture of claim 35 wherein the amount of methanol in the fuel is about 0.1 to about 99 wt %.

37. The fuel mixture of claim 34 wherein said at least one Lewis base is an organic compound.

38. The fuel mixture of claim 34 wherein said at least one Lewis base is selected from the group consisting of imidazoline, piperidine, piperazine, pyrrolidine, aziridine, azetidine, imidazole, pyrazole, pyridine, and their substituted forms.

39. The fuel mixture of claim 34 wherein said at least one Lewis base is selected from the group consisting of imidazoline and piperidine.

40. The fuel mixture claim 34 wherein said at least one Lewis base in said fuel mixture has a concentration of at least about 0.001 M.

41. A container of a fuel mixture comprised of methanol and at least one Lewis base.

42. The container of claim 41 wherein said fuel mixture further comprises water.

43. The container of claim 41 wherein said container is substantially nonvitreous.

44. The container of claim 41 further comprising a dispensing port for supplying said fuel mixture to a direct methanol fuel cell.

45. The container of claim 44 wherein said dispensing port is comprised of a septum.
